(19) United States
(12) Patent Application Publication
(10) Pub. No.: US 2006/0187750 A1
(43) Pub. Date: Aug. 24, 2006

(54) Rotary blending apparatus and system

(76) Inventors: Victor Aldrich, Ware (GB); Steven George Chapman, Ware (GB); Lee Paul Hoenderkamp, Ware (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/506,346

(22) PCT Filed: Feb. 24, 2003
(86) PCT No.: PCT/US03/05680

§ 371 Date: May 2, 2005

Related U.S. Application Data
(60) Provisional application No. 60/360,729, filed on Mar. 1, 2002.

(51) Int. Cl. B01F 7/22

(52) U.S. Cl. 366/270; 366/330.3; 416/239

(57) ABSTRACT

A rotary blending apparatus and system comprising a hub (10) and a plurality of substantially angularly spaced impeller blades (20). The unique, variable configuration of the impeller blades produces optimum flow patterns and, hence, highly efficient mixing of solids and liquids. The blending apparatus is also scalable to multiple sizes without compromising mixing performance.

### FIELD OF THE PRESENT INVENTION

The present invention relates generally to blending systems. More particularly, the invention relates to a blending apparatus and system for mixing compositions, particularly, dry powder pharmaceutical compositions.

### BACKGROUND OF THE INVENTION

It is well known that pharmaceutical compositions in the form of a dry powder may advantageously be administered by inhalation to or through the lung of a patient. In inhalation therapy, a pharmaceutical delivery device, such as a dry powder inhaler (“DPT”), is typically employed to deliver a prescribed dose of a pharmaceutical composition and, hence, medicament to the pulmonary system of a patient. As is well known in the art, in a typical DPI, a dose of the pharmaceutical composition is positioned in an aerosolization chamber, where it is aerosolized and, hence, dispersed into respirable particles by airflow supplied by a pressurized source of gas or by the patient's inspiration effort. It is also well known in the art that in order to settle in the appropriate regions of the lung associated with local and/or systemic drug delivery, the dispersed particles must be of suitable size.

The pulmonary system includes the upper airways, including the oropharynx and larynx, followed by the lower airways, which include the trachea followed by bifurcations into bronchi and bronchioli. The upper and lower airways are called the conducting airways. The terminal bronchioli then divide into respiratory bronchioli, which then lead to the alveolar region, or the deep lung. See, Gonda, I, “Aerosols for Delivery of Therapeutic and Diagnostic Agents to the Respiratory Tract”, Critical Reviews in Therapeutic Drug Carrier Systems, vol. 6, pp. 273-313 (1990).

The smooth muscle regions of the conducting airways, and particularly the lower airways, possess receptors (i.e., protein based, macromolecular complexes existing within cell membranes which, upon interaction with specific agents, change conformation and lead to the triggering of a cellular response, such as smooth muscle cell contraction or relaxation) that are the primary target site of local medicament particle delivery. The alveolar region of the deep lung, although it too may possess receptors effecting local response, is the target site for pulmonary systemic delivery, as the alveoli provide access to vascular system through a closely associated vascular capillary network.

It is well known that medicament particles deposit in specific areas of the pulmonary system based upon the aerodynamic size of the particles and the flow rate of the fluid within which they are entrained. Typically, with average inhalation flow rates of between 10 and 60 liters per minute, particles having an aerodynamic diameter in the range of 0.5 to 3 μm are suitable for systemic delivery, as these particles deposit selectively in the deep lung. Particles having an aerodynamic diameter in the range of approximately 0.5 to 10 μm, preferably, 1 to 6 μm, and more preferably, 3 to 6 μm are suitable for local lung delivery, as they will deposit in the conductive airways.

Particles having an aerodynamic diameter greater than 10 μm generally deposit in the mouth, throat or upper airways, offering little therapeutic benefit. Particles having an aerodynamic diameter less than 0.5 μm do not settle out of the airflow to deposit in the lungs, and are subsequently respired when the patient exhales.

The effectiveness of dry powder pharmaceutical composition delivery thus depends upon the ability to precisely and reproducibly meter small quantities of medicament into doses. The metering is typically achieved by diluting the medicament in a pharmaceutical composition. The pharmaceutical composition can then be metered with a greater margin of error than a highly potent medicament alone.

The pharmaceutical compositions are desirably highly aerosolizable to clear the composition from the inhaler device and disperse the composition into particles of respirable size. Measurements of aerosolizibility and dispersiblity may be made by measuring the emitted dose and fine particle fraction of the composition, respectively, using methodologies known to the art. A common device used in measuring fine particle fraction is an Anderson Cascade Impactor.

It is further desired that the pharmaceutical composition be sufficiently flowable to permit the composition to be poured or otherwise transferred into individual doses. Measures of flowability are typically quantified by the compressibility of the powder composition, as well as its “angle of repose.” The measurement of these features is typically made using standardized methodologies known in the art.

Efforts in the area of meterability have long included the use of excipients, such as milled or micronized lactose, to dilute the medicament in the pharmaceutical composition, allowing microgram quantities of very potent medicaments to be precisely metered into milligram sized doses with an acceptable degree of control. Blending of the excipient(s) and medicament must, however, provide a dry powder pharmaceutical composition that exhibits substantial homogeneity with respect to the medicament and uniformity of particle size distribution. Indeed, the noted criteria are essential to ensure that the correct therapeutic dose of the medicament is delivered to the patient.

Various conventional blending apparatus and systems have been employed in an effort to produce homogenous, uniform dry powder pharmaceutical compositions. Such systems include tumble mixers and high shear impeller design systems. The conventional systems are, however, often fraught with numerous disadvantages and drawbacks. Among the disadvantages are the unacceptably high power input required per unit volume of blend, system complexity and high cost. Further, the mixer blade or impeller design that is employed is often limited in its ability to provide an optimum flow pattern over a range of power input and be scaled up (or down) without compromising blending performance.

Thus, there exists a need to provide a blending apparatus and system that consistently provides an optimum flow pattern over a broad range of power input and, hence, optimum blending performance. There also exists a need to provide a blending apparatus and system that can be readily scaled up or down without compromising blending performance.

It is therefore an object of the present invention to provide a blending apparatus and system that overcomes the aforementioned disadvantages and drawbacks associated with conventional blending apparatus and systems.

It is another object of the present invention to provide a blending apparatus and system that is capable of creating optimum motion or flow of the blend (e.g., powder) for a given amount of energy expended.

It is another object of the present invention to provide a blending apparatus and system that is capable of creating optimum motion or flow of the blend over a broad range of power input.

It is another object of the invention to provide a blending apparatus and system that is capable of achieving the required process performance with less power and in a shorter period of time as compared to conventional blending systems.

It is another object of the invention to provide a blending apparatus and system that produces substantially homogenous pharmaceutical compositions that are suitable for inhalation therapy.

It is yet another object of the invention to provide a blending apparatus and system that produces pharmaceutical compositions having a high degree of aerosolibility and dispersability.

### SUMMARY OF THE INVENTION

In accordance with the above objects and those that will be mentioned and will become apparent below, the rotary blending apparatus and system in accordance with this invention comprises a hub having an outer diameter and a plurality of substantially angularly spaced impeller blades, each of the impeller blades having a first and second baffle, the first baffle having a first end rigidly connected to the hub and forming a first impeller angle with respect to the vertical axis of the hub in the range of approximately 110°-130°, the second end of said first baffle having a substantially lineai edge forming a second impeller angle with respect to the longitudinal axis of the hub in the range of 40°-50°, the second baffle being rigidly connected to the second end of the first baffle whereby the first and second baffles form a third impeller angle in the range of approximately 85°-95°.

In one embodiment of the invention, the geometric and dimensional relationship of the hub and impellers define a first blending apparatus size that provides a first flow pattern of the blend (or composition) during mixing.

In a preferred embodiment, the blending apparatus is scalable to at least a second blending apparatus size that provides a second flow pattern that is substantially similar to the first flow pattern.

The advantages of this invention include the provision of a blending apparatus (i.e., impeller) and system that is capable of producing optimum flow patterns and, hence, substantially homogenous pharmaceutical compositions having a substantially uniform particle size distribution and a high degree of aerosolibility and dispersability. A further advantage is the capability of the blending apparatus to be readily scaled up or down without compromising blending performance.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 a perspective view of one embodiment of the blending apparatus according to the invention;

FIG. 2 is a top plan view of the blending apparatus shown in FIG. 1, according to the invention;

FIG. 3 is a partial side elevational view of the blending apparatus shown in FIG. 1, according to the invention;

FIG. 4 is a partial sectional front elevational view of the blending apparatus shown in FIG. 1, according to the invention;

FIG. 5 is a right side elevational view of the blending apparatus shown in FIG. 1, according to the invention;

FIG. 6 is a left side elevational view of the blending apparatus shown in FIG. 1, according to the invention;

FIG. 7 is a schematic illustration of a preferred blend flow pattern resulting from the blending apparatus of the invention;

FIG. 8 is a schematic illustration of the mechanical impact and shear forces imparted on a blend by the blending apparatus of the invention;

FIG. 9 is a graphical illustration of the relationship of the impact and shear forces as a function of the second impeller angle, according to the invention; and

FIG. 10 is an elevational view of one embodiment of the blending system, according to the invention.

### DETAILED DESCRIPTION OF THE PREFERRED EMBODIMENT

Before describing the present invention in detail, it is to be understood that this invention is not limited to particularly exemplified method or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety.

It must also be noted that, as used in this specification and the appended claims, the singular forms “a,” “an” and “the” include plural referents unless the content clearly dictates otherwise.

Further, unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In describing the present invention, the following terms will be employed, and are intended to be defined as indicated below.

Definitions

By the term “medicament”, as used herein, is meant to mean and include any substance (i.e., compound or composition of matter) which, when administered to an organism (human or animal) induces a desired pharmacologic and/or physiologic effect by local and/or systemic action. The term therefore encompasses substances traditionally regarded as actives, drugs and bioactive agents, as well as biopharmaceuticals (e.g., peptides, hormones, nucleic acids, gene constructs, etc.), including, but not limited to, analgesics, e.g., codeine, dihydromorphine, ergotamine, fentanyl or morphine; anginal preparations, e.g., diltiazem; antiallergics, e.g., cromoglycate (e.g., as the sodium salt), ketotifen or nedocromil (e.g., as the sodium salt); antiinfectives, e.g., cephalosporins, penicillins, streptomycin, sulphonamides, tetracyclines and pentamidine; antihistamines, e.g., methapyrilene; anti-inflammatories, e.g., beclomethasone (e.g., as the dipropionate ester), fluticasone (e.g., as the propionate ester), flunisolide, budesonide, rofleponide, mometasone (e.g., as the furoate ester), ciclesonide, triamcinolone (e.g., as the acetonide) or 6α,9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., albuterol (e.g., as free base or sulfate), salmeterol (e.g., as xinafoate), ephedrine, adrenaline, fenoterol (e.g., as hydrobromide), formoterol (e.g. as fi umarate), isoprenaline, metaproterenol, phenylephrine, phenylpropanolamine, pirbuterol (e.g., as acetate), reproterol (e.g., as hydrochloride), rimiterol, terbutaline (e.g., as sulfate), isoetharine, tulobuterol or 4-hydroxy-7-[2-[[2-[[3-(2-phenylethoxy)propyl]sulfonyl]ethyl]amino]ethyl-2(3H)-benzothiazolone; adenosine 2a agonists, e.g., (2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g., as maleate); α₄ integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid (e.g., as free acid or potassium salt), diuretics, e.g ., amiloride; anticholinergics, e.g., ipratropium (e.g. as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagon. The noted medicaments may also be employed in the form of salts, (e.g., as alkali metal or amine salts or as acid addition salts) or as esters (e.g., lower alkyl esters) or as solvates (e.g., hydrates) to optimize the activity and/or stability of the medicament.

The term “medicament ” further includes formulations containing combinations of active ingredients, including, but not limited to, salbutamol (e.g., as the free base or the sulfate salt) or salmeterol (e.g., as the xinafoate salt) or formoterol (e.g., as the fumarate salt) in combination with an anti-inflammatory steroid such as a beclomethasone ester (e.g., the dipropionate), a fluticasone ester (e.g., the propionate), a furoate ester or budesonide.

By the term “pharmaceutical composition”, as used herein, it is meant to mean a combination of at least one medicament and one or more added components or elements, such as an “excipient” or “carrier.” As will be appreciated by one having ordinary skill in the art, the terms “excipient” and “carrier” generally refer to substantially inert materials that are nontoxic and do not interact with other components of the composition in a deleterious manner. Examples of normally employed “excipients,” include pharmaceutical grades of carbohydrates including monosaccharides, disaccharides, cyclodextrins and polysaccharides (e.g., dextrose, sucrose, lactose, raffinose, mannitol, sorbitol, inositol, dextrins and maltodextrins); starch; cellulose; salts (e.g., sodium or calcium phosphates, calcium sulfate, magnesium sulfate); citric acid; tartaric acid; glycine; leucine; high molecular weight polyethylene glyols (PEG); pluronics; surfactants; lubricants; stearates and their salts or esters (e.g., magnesium stearate, calcium stearate); amino acids; fatty acids; and combinations thereof. Examples of suitable “carriers” include water, silicone, gelatin, waxes, and like materials.

By the terms “blend” and “composition”, as used herein, it is meant to mean one or more substances or elements in the form of a powder or liquid or combination thereof. The term “composition” thus includes dry powder pharmaceutical compositions and the aforementioned medicaments.

By the term “mixing”, as used herein, it is meant to mean and include blending, dispersion and emulsifying of a “blend” or “composition”.

By the term “pharmaceutical delivery device”, as used herein, it is meant to mean a device that is adapted to administer a controlled amount of a composition to a patient, including, but not limited to, the Diskus® device disclosed in U.S. Pat Nos. Des. 342,994; 5,590,654, 5,860,419; 5,837,630 and 6,032,666; the Diskhaler™ device disclosed in U.S. Pat. Nos. Des 299,066; 4,627,432 and 4,811,731; the Rotohaler™ device disclosed in U.S. Pat. No. 4,778,054; the Cyclohaler™ device by Norvartis; the Turbohaler™ device by Astra Zeneca; the Twisthaler™ device by Scheling Plough; the Handihaler™ device by Boehringer Engelheim; the Airmax™ device by Baker-Norton; and the Dura and Inhaled Therapeutic active delivery systems. Each of the noted “pharmaceutical delivery devices” are incorporated by reference herein.

As will be appreciated by one having ordinary skill in the art, the present invention substantially reduces or eliminates the disadvantages and drawbacks associated with conventional blending apparatus and systems. As discussed in detail below, the blending apparatus and system of the invention provides an optimum, highly turbulent flow regime during the mixing (or blending) process, resulting in substantially homogeneous dry powder pharmaceutical compositions that are particularly suitable for inhalation therapy. The blending apparatus and system also allows broad ranges of power input and impeller tip speeds to be employed without adversely affecting the mixing performance and, hence, homogeneity of the pharmaceutical compositions. The ability to employ a broad range of power input and the control thereof further facilitates a high degree of control of the fine particle mass (FPM) performance of the pharmaceutical compositions.

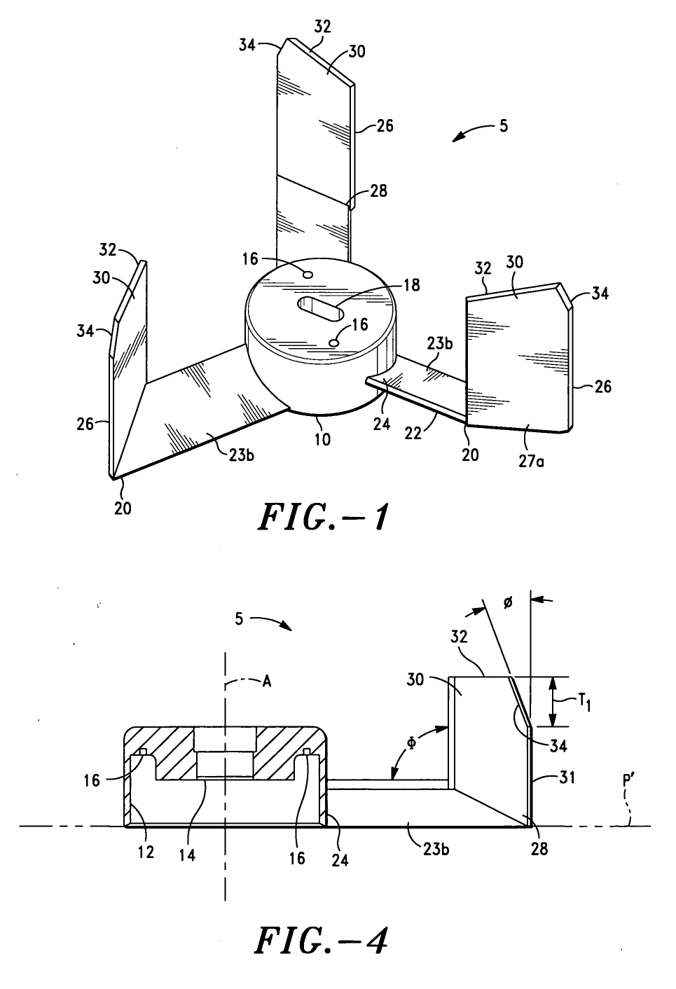

Referring now to FIGS. 1 and 2, there is shown the blending apparatus 5 of the invention. As illustrated in FIG. 1, the blending apparatus 5 includes a hub 10 and a plurality of substantially equally spaced impeller blades 20 attached thereto.

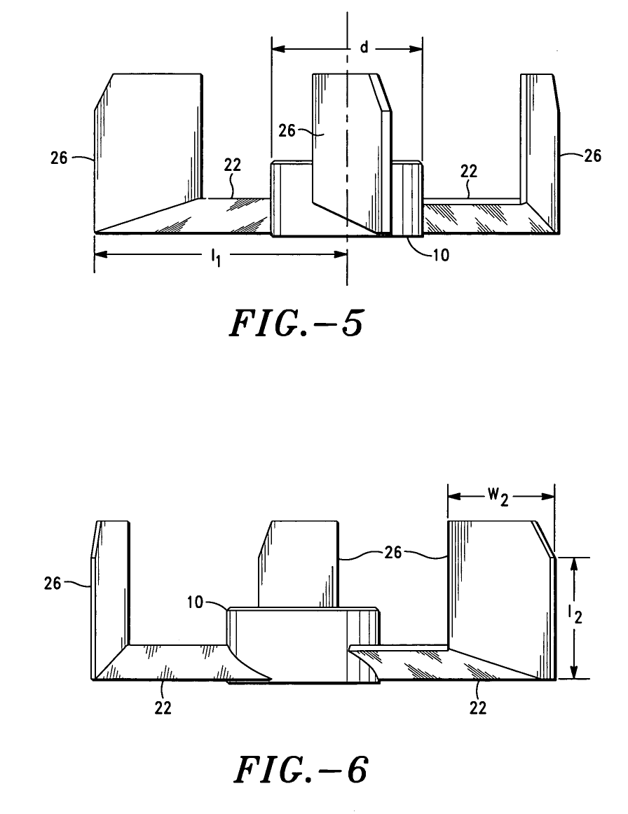

According to the invention, the hub 10 is adapted to receive and operatively engage a rotatable blending system shaft 48 (see FIG. 8). In one embodiment of the invention, illustrated in FIGS. 2 and 4, the hub 10 comprises a substantially circular member having an interior portion 12 and shaft seat 14. The hub 10 preferably has an outer diameter d in the range of 139.0 to 141.0 mm, more preferably, 139.8 to 140.2 mm (see FIG. 5).

To facilitate engagement of the hub 10 to the rotatable system shaft 48, the hub 10 includes a pair of equally spaced holes 16 that are preferably disposed on the shaft seat 14. As illustrated in FIG. 2, also disposed centrally on the shaft seat 14 is a shaft engagement slot 18.

Referring back to FIGS. 1 and 2, each impeller blade 20 of the invention includes first and second baffles 22, 26. The first baffle 22 is preferably a substantially flat, elongated member having first and second planar surfaces 23a, 23b and a root portion 24 proximate to the hub 10.

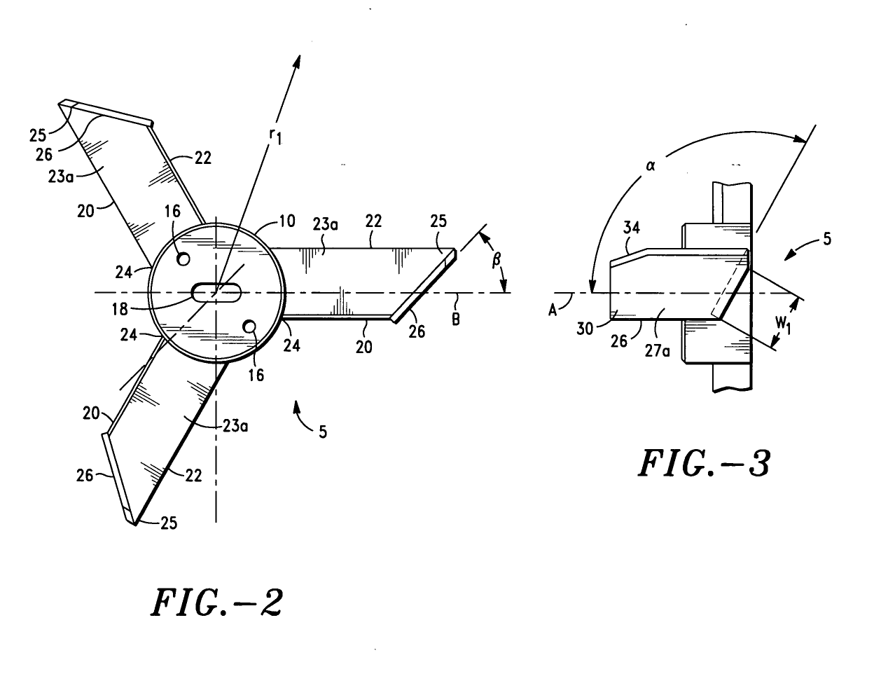

According to the invention, the first baffle 22 preferably has a length l₁ in the range of 245.0 to 247.0 mm and a width w₁ in the range of 70.0 to 75.0 mm (see FIGS. 3 and 5). More preferably, the length l₁ is in the range of 246.0 to 246.75 mm and the width w₁ is in the range of 72.0 to 74.0 mm.

The second baffle 26 preferably has a length l₂ in the range of 139.0 to 141.0 mm and a width w₂ in the range of 96.0 to 98.0 mm (see FIG. 6). More preferably, the length l₂ is in the range of 139.8 to 140.2 mm and the width w₂ is in the range of 96.8 to 97.2 mm.

In a preferred embodiment of the invention, the first baffle 22 forms a first impeller angle α with respect to the vertical axis of the hub 10 (designated A) in the range of approximately 110°-130° that substantially uniformly extends from the root portion 24 to the distal end 25 of the first baffle 22 (see FIG. 3). More preferably, the first impeller angle α is approximately 120°.

Referring to FIG. 2, the distal end 25 of the first baffle 22 preferably forms a second impeller angle β with respect to the longitudinal axis of the first baffle 22 (designated B) in the range of approximately 40°-50°. More preferably, the second impeller angle β is approximately 45°.

Referring now to FIGS. 1 and 4, the second baffle 26 is similarly preferably a substantially flat, elongated member having first and second planar surfaces 27a, 27b, an engagement portion (or end) 28 and a tip portion.30. As illustrated in FIG. 4, the engagement end 28 is connected to the distal end 25 of the first baffle 26. Preferably, the first baffle 22 and second baffle 26 form a third impeller angle Φ in the range of approximately 85°-95°. More preferably, the third impeller angle is approximately 90°.

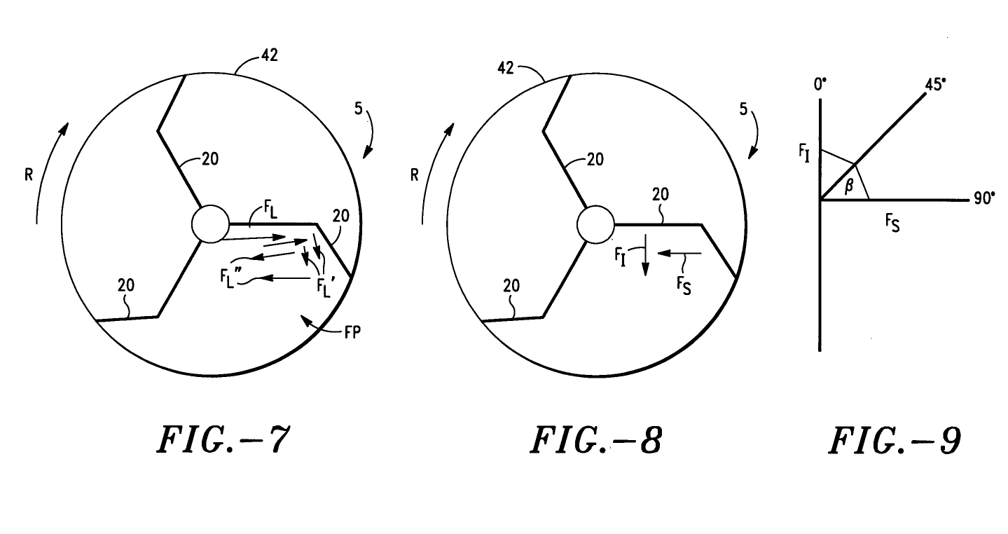

According to the invention, α, β, Φ, d, l₁, l₂, w₁ and w₂ define a core geometric and dimensional relationship. In one embodiment of the invention, α, β, Φ, d, l₁, l₂, w₁ and w₂ further define a first blending apparatus size having a tip radius r₁. According to the invention, the first blending apparatus size provides a flow pattern FP substantially as illustrated in FIG. 7 and discussed in detail below.

Referring back to FIG. 4, the tip portion 30 of the second baffle 26 preferably includes a substantially flat tip edge 32. According to one embodiment of the invention, the tip edge 32 is preferably substantially parallel to the horizontal plane (designated generally P′) formed by the first baffle(s) 22.

Preferably disposed on the radial portion of the tip edge 32 is a tip relief 34. According to the invention, the tip relief 34 forms a relief angle Ø with respect to the leading edge 31 of the second baffle 26 that is preferably in the range of approximately 25° to 35°.

Advantageously, in one embodiment, the outside comer of the tip edge may be removed so as to allow the impeller to be fitted and removed with little, if any, in-bowl assembly or sunken bolts.

In a preferred embodiment, the blending apparatus 5 is constructed out of a material suitable for pharmaceutical processes, such as stainless steel. The hub 10 and first and second baffles 22, 26 are also preferably interconnected by welding to form an integrated one-piece unit.

As indicated above, a key advantage of the blending apparatus 5 (and, hence, system 40) of the invention is that it is readily scalable, i.e., scaled up or down, to at least a second blending apparatus size having a tip radius r₂ that provides a flow pattern FP′ that is substantially equal to FP; provided, (i) the container clearance (designated C_{c} in FIG. 8 and discussed in detail below) is maintained in the range of 2 to 3 mm, (ii) the impeller angles α, β and Φ are maintained within the above recited preferred ranges, and (iii) the core geometric and dimensional relationship of d, l₁, l₂, w₁, and w₂ is maintained, i.e.,
d₁=SF×d Eq. 1
l₃=SF×l₁ Eq. 2
l₄=SF×l₂ Eq. 3
w₃=SF×w₁ Eq. 4
w₄=SF×w₂ Eq. 5
where

SF=scale factor (e.g., 1.3);

d₁=hub diameter of scaled blending apparatus;

l₃=first baffle length of scaled blending apparatus;

l₄=second baffle length of scaled blending apparatus;

w₃=first baffle width of scaled blending apparatus; and

w₄=second baffle width of scaled blending apparatus.

Referring now to FIG. 7, there is shown a schematic illustration of the variable and, hence, highly turbulent flow pattern achieved by virtue of the blending apparatus 5 of the invention (designated generally FP). According to the invention, during rotation of the blending apparatus 5 in a direction denoted by Arrow R, the blend (e.g., dry powder pharmaceutical composition) passing over the impeller blades 20 flows in multiple directions, including upwardly by virtue of the second planar surface 23b of the first baffle 22 and first impeller angle α and substantially rotationally proximate each impeller blade 20, denoted by Arrows F_{L}, F_{L}′, F_{L}″, by virtue of the second planar surface 27b of the second baffle 26 and second impeller angle β.

More particularly, the impeller blades 20 impart from the periphery of the mixing container 42 to the blend an inwardly directed, high velocity thrust having a dominating axial component that creates an intense hydraulic s hear in the blend. At the same time, the impeller blades 20 also impart to each of the blend streams a mechanical shear force (discussed below) that further contributes to the blending and dispersion of the blend.

Applicants have further found that the reverse flow of the blend, denoted by Arrows F_{L}″, substantially reduces, and in most instances eliminates, the effects of an increasing pressure drop across the impeller blades 20, which is often encountered with conventional impellers.

Referring now to FIG. 8, there is shown a schematic illustration of the mechanical impact and shear forces, denoted F_{I}, F_{S}, respectively, generally imparted on the blend by each impeller blade 20. As illustrated in FIG. 8, the mechanical impact force, F_{I}, is generally imparted in a direction substantially perpendicular to the impeller blade 20. The mechanical shear force, F_{S}, is generally imparted to the blend in a direction approximately parallel to the longitudinal axis of the impeller blade 20 (i.e., axially).

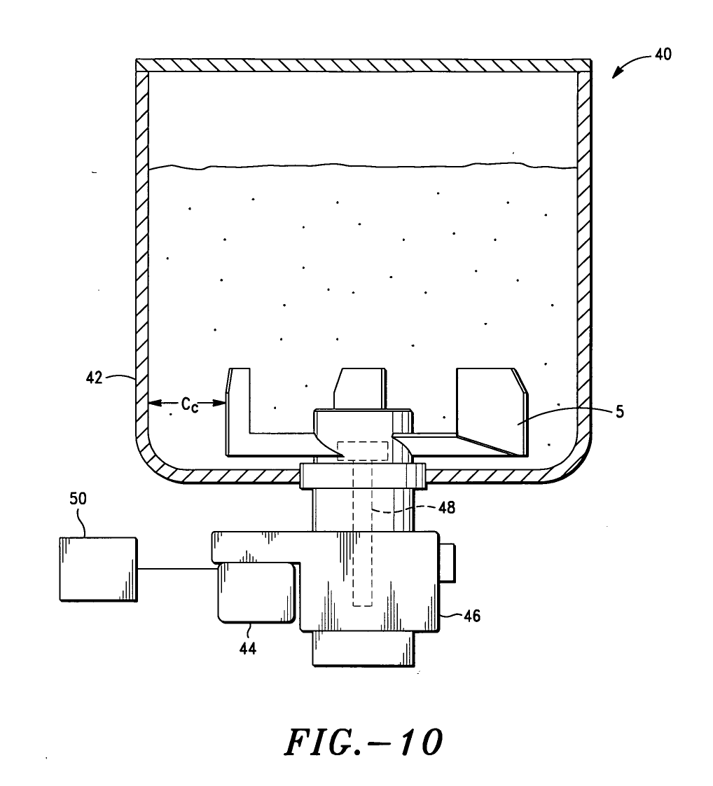

According to the invention, the ratio of F_{I}/F_{S}, which is a key factor in achieving desired blending performance, can be varied as a function of the second impeller angle β. As illustrated in FIG. 9, the ratio F_{I}/F_{S} can be determined from the following relationship:
1/tan β=F_{I}/F_{S} Eq. 6

As indicated above, in one embodiment of the invention, a second impeller angle β of approximately 45° is employed. The noted second impeller angle β thus yields a substantially equal ratio of F_{I}/F_{S}.

Applicants have found the noted relationship provides an optimum, highly turbulent flow pattern over broad ranges of power input (e.g., 600-900 W) and blend volumes (e.g., 12 kg to 25 kg). The noted relationship also allows significantly higher impeller tip speeds to be employed (e.g., 140 to 300 rpm) without compromising blending performance.

As will be appreciated by one having ordinary skill in the art, the flow pattern produced by the blending apparatus 5 described above can be varied and/or tailored to achieve a specific mixing parameter (or regime) by varying the core geometric and dimensional relationship. The blending apparatus 5 can similarly be tailored to accommodate effective mixing of various forms of blends (e.g., liquid, slurry, etc.).

Referring now to FIG. 10, there is shown one embodiment of the blending system 40 of the invention. The blending system 40 includes the blending apparatus 5 described above, a mixing container 42, power transmission means (e.g., motor) 44, a drive assembly 46, a rotatable shaft 48 and control means 50.

The mixing container 42 of the invention is preferably constructed out of stainless steel or like material and has a substantially circular shape. The container 42 also includes conventional means (e.g., ports) for receiving and discharging the blend 100 (not shown).

According to the invention, the power transmission means 44 is operatively connected to the drive assembly 46, which, in turn, is connected to and rotates the rotatable shaft 48. As indicated above, the rotatable shaft 48 is adapted to engage the hub 10 of the blending apparatus 5 and, hence, impart rotational energy thereto.

As will be appreciated by one having ordinary skill in the art, various power transmission means may be employed within the scope of the invention to drive the drive assembly 46. In a preferred embodiment, the power transmission means comprises a 7.5 kw motor.

Similarly, various control means 50 can be employed to control the power transmission means 44 and drive assembly 46 of the invention. Preferably, the control means 50 comprises a computer that is programmed and adapted to monitor and regulate the power input and tip speed of the blending apparatus 5.

As indicated above, the blending apparatus and system of the invention is capable of producing optimum flow patterns and, hence, substantially homogenous dry powder pharmaceutical compositions having a substantially uniform particle size distribution and a high degree of aerosolibility and dispersability. The pharmaceutical compositions are thus particularly suitable for inhalation therapy. Accordingly, a further aspect of the present invention comprises pharmaceutical compositions, including particulate medicament particles (i.e., neat drugs), blended in accordance with the present invention.

It will be appreciated by those skilled in the art that the pharmaceutical compositions blended in accordance with the invention can, if desired, contain a combination of two or more medicaments or components, including combinations of bronchodilatory agents (e.g., ephedrine and theophylline, fenoterol and ipratropium, and isoetharine and phenylephrine formulations).

Other pharmaceutical compositions may contain bronchodilators such as salbutamol (e.g. as the free base or as the sulphate salt), salmeterol (e.g. as the xinafoate salt), formoterol or isoprenaline in combination with an anti-inflammatory steroid such as a beclomethasone ester (e.g. the dipropionate) or a fluticasone ester (e.g. the propionate) or a bronchodilator in combination with an antiallergic such as cromoglycate (e.g. the sodium salt). A particularly preferred combination is a combination of fluticasone propionate and salmeterol, or a salt thereof (particularly the xinafoate salt). A further combination is budesonide and formoterol (e.g., as the fumarate salt).

It is to be understood that the present invention covers each of the noted medicaments and compounds, all physiologically acceptable derivatives thereof, and all combinations of particular and preferred groups described hereinabove. The term “physiologically acceptable derivative”, as used herein, refers to any physiologically acceptable derivative of a compound of the present invention, for example, an ester, which upon administration to a mammal, such as a human, is capable of providing (directly or indirectly) such a compound or an active metabolite thereof. Such derivatives are clear to those skilled in the art, without undue experimentation, and with reference to the teaching of Burger's Medicinal Chemistry And Drug Discovery, 5th Edition, Vol 1: Principles And Practice, which is incorporated herein by reference.

The pharmaceutical compositions blended in accordance with the invention can conveniently be filled into a bulk storage container, such as a multi-dose reservoir, or into unit dose containers such as capsules, cartridges or blister packs, which may be used with an appropriate pharmaceutical delivery device, for example, as described in GB2041763, WO91/13646, GB1561835, GB2064336, GB2129691 or GB2246299, which are incorporated by reference herein. The noted devices and aforementioned pharmaceutical delivery devices containing a pharmaceutical composition blended in accordance with the invention are deemed novel and, hence, form a further aspect of the invention.

The pharmaceutical compositions formed in accordance with the invention are particularly suitable for use with multi-dose reservoir-type devices in which the composition is metered, e.g. by volume from a bulk powder container into dose-metering cavities. The lower limit of powder delivery, which may be accurately metered from a multi-dose reservoir-type device, is typically in the range of 100 to 200 micrograms. The noted pharmaceutical compositions are therefore particularly advantageous for highly potent and, hence, low dose medicaments that require a high ratio of excipient for use in a multi-dose reservoir-type device.

### SUMMARY

From the foregoing description, one of ordinary skill in the art can easily ascertain that the present invention provides a blending apparatus and system that is capable of producing optimum flow pattern(s) over a range of power input and, hence, substantially homogenous pharmaceutical compositions having a substantially uniform particle size distribution and a high degree of aerosolibility and dispersability. A further advantage is the capability of the blending apparatus to be readily scaled up or down without compromising blending performance.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A rotary blending apparatus for mixing a composition, comprising:
a hub; and
a plurality of substantially angularly spaced impeller blades, each of said impeller blades having a first and second baffle,
said first baffle having first and second ends, said first end being rigidly connected to said hub, said first baffle forming a first impeller angle with respect to the vertical axis of said hub in the range of approximately 110°-130°, said second end of said first baffle having a substantially linear edge forming a second impeller angle with respect to the longitudinal axis of said hub in the range of 40°-50°,
said second baffle having first and second ends, said first end of said second baffle being rigidly connected to said second end of said first baffle, said first and second baffles forming a third impeller angle in the range of approximately 85°-95°.

2. The apparatus of claim 1, wherein said composition comprises a dry powder.

3. The apparatus of claim 2, wherein said dry powder comprises a pharmaceutical composition.

4. The apparatus of claim 1, wherein said hub has an outer diameter in the range of 139.0 to 141.0 mm.

5. The apparatus of claim 1, wherein said first baffle has a first length in the range of 245.0 to 247.0 mm and a first width in the range of 70.0 to 75.0 mm.

6. The apparatus of claim 1, wherein said second baffle has a second length in the range of 139.0 to 141.0 mm and a second width in the range of 96.0 to 98.0 mm.

7. The apparatus of claim 1, wherein each of said impellers impart impact and shear forces to said composition during rotation of said apparatus.

8. The apparatus of claim 7, wherein the ratio of said impact and shear forces is substantially equal to 1/tan (second impeller angle).

9. The apparatus of claim 1, wherein said first and second baffles comprise substantially flat, elongated members.

10. The apparatus of claim 9, wherein said first impeller angle extends substantially uniformly from said first end to said second end of said first baffle.

11. The apparatus of claim 1, wherein said hub outer diameter, said first and second lengths, said first and second widths, and said first, second and third impeller angles define a first blending apparatus size have a first tip radius, said first blending apparatus size providing a first flow pattern of said composition during rotation of said apparatus.

12. The apparatus of claim 11, wherein said first flow pattern includes a reverse flow component.

13. The apparatus of claim 11, wherein said apparatus is scalable to at least a second blending apparatus size having a second tip radius, said second blending apparatus size providing a second flow pattern that is substantially similar to said first flow pattern.

14. A rotary blending apparatus for mixing a pharmaceutical composition, comprising:
a hub having an outer diameter in the range of 139.0 to 141.0 mm; and
a plurality of substantially angularly spaced impeller blades, each of said impeller blades having a first and second baffle,
said first baffle having first and second ends, a first length in the range of 245.0 to 247.0 mm and a first width in the range of 70.0 to 75.0 mm,
said first end of said first baffle being rigidly connected to said hub, said first baffle forming a first impeller angle with respect to the vertical axis of said hub in the range of approximately 110°-130°, said second end of said first baffle having a substantially linear edge forming a second impeller angle with respect to the longitudinal axis of said hub in the range of 40°-50°,
said second baffle having first and second ends, a second length in the range of 139.0 to 141.0 mm and a second width in the range of 96.0 to 98.0 mm,
said first end of said second baffle being rigidly connected to said second end of said first baffle, said first and second baffles forming a third impeller angle in the range of approximately 85°-95°,
said hub outer diameter, said first and second lengths, said first and second widths, and said first, second and third impeller angles defining a first blending apparatus size have a first tip radius, said first blending apparatus size providing a first flow pattern of said composition during rotation of said apparatus,
said apparatus being scalable to at least a second blending apparatus size having a second tip radius, said second blending apparatus size providing a second flow pattern that is substantially similar to said first flow pattern.

15. The apparatus of claim 14, wherein said pharmaceutical composition comprises a dry powder.

16. The apparatus of claim 14, wherein each of said impellers impart impact and shear forces to said composition during rotation of said apparatus.

17. The apparatus of claim 16, wherein the ratio of said impact and shear forces is substantially equal to 1/tan (second impeller angle).

18. The apparatus of claim 14, wherein said first and second baffles comprise substantially flat, elongated members.

19. The apparatus of claim 18, wherein said first impeller angle extends substantially uniformly from said first end to said second end of said first baffle.

20. The apparatus of claim 14, wherein said first flow pattern includes a reverse flow component.

21. A rotary blending system for mixing a composition, comprising:
a mixing container having a mixing chamber;
a rotatable drive shaft; and
a rotary blending apparatus disposed in said mixing chamber, said rotary blending apparatus being connected to said drive shaft, said rotary blending apparatus including a hub and a plurality of substantially angularly spaced impeller blades, each of said impeller blades having a first and second baffle, said first baffle having first and second ends, said first end being rigidly connected to said hub, said first baffle forming a first impeller angle with respect to the vertical axis of said hub in the range of approximately 110°-130°, said second end of said first baffle having a substantially linear edge forming a second impeller angle with respect to the longitudinal axis of said hub in the range of 40°-50°, said second baffle having first and second ends, said first end of said second baffle being rigidly connected to said second end of said first baffle, said first and second baffles forming a third impeller angle in the range of approximately 85°-95°.

22. The system of claim 20, wherein said hub has an outer diameter in the range of 139.0 to 141.0 mm.

23. The system of claim 20, wherein said first baffle has a first length in the range of 245.0 to 247.0 mm and a first width in the range of 70.0 to 75.0 mm.

24. The system of claim 20, wherein said second baffle has a second length in the range of 139.0 to 141.0 mm and a second width in the range of 96.0 to 98.0 mm.

25. The system of claim 20, wherein each of said impellers impart impact and shear forces to said composition during rotation of said apparatus.

26. The system of claim 25, wherein the ratio of said impact and shear forces is substantially equal to 1/tan (second impeller angle).

27. The system of claim 20, wherein said first and second baffles comprise substantially flat, elongated members.

28. The system of claim 27, wherein said first impeller angle extends substantially uniformly from said first end to said second end of said first baffle.

29. The system of claim 20, wherein said hub outer diameter, said first and second lengths, said first and second widths, and said first, second and third impeller angles define a first blending apparatus size have a first tip radius, said first blending apparatus size providing a first flow pattern of said composition during rotation of said apparatus.

30. The system of claim 29, wherein said first flow pattern includes a reverse flow component.

31. The system of claim 29, wherein said apparatus is scalable to at least a second blending apparatus size having a second tip radius, said second blending apparatus size providing a second flow pattern that is substantially similar to said first flow pattern.
